(19) United States
(12) Patent Application Publication
(10) Pub. No.: US 2017/0351815 A1
(43) Pub. Date: Dec. 7, 2017

(54) PATIENT MANAGEMENT SYSTEM FOR INTERPHYSICIAN COMMUNICATIONS

(71) Applicant: Kathleen Schmelka, Hinsdale, IL (US)

(72) Inventor: Kathleen Schmelka, Hinsdale, IL (US)

(21) Appl. No.: 15/172,847

(22) Filed: Jun. 3, 2016

(51) Int. Cl. G06F 19/00

(52) U.S. Cl. CPC G06F 19/322; G06F 19/345

(57) ABSTRACT

A secure patient management system that allows for real-time tracking of patient care and provides secure interphysician communication to streamline physician interactions is provided. This system is compatible with computers, tablets, smartphones, and other mobile devices, allowing physicians to communicate directly with one another in real time or send delayed messages to prevent unnecessary interruptions. In addition, this system operates on a secure cloud and can integrate with current electronic medical records and electronic health record systems to document and save time-stamped communications, thus decreasing medicolegal liability.

### BACKGROUND OF THE INVENTION

The management of hospitals and patient care requires adherence to strict liability standards, and many rules are in place to protect both the patient and the physician. If a patient enters the emergency department of a hospital and needs to be admitted, the admission requires communication between the emergency physician and an admitting physician, either a primary care doctor or hospitalist. Often, consulting specialist physicians are also called upon to examine the patient and assist in diagnosis and treatment. Even if the patient is discharged from the emergency department without hospital admission, the emergency physician may need to communicate with another physician regarding the follow-up of that patient.

Most emergency departments are currently set up to have a main tracking board that lists patient information such as room number, nurse and physician assignments, and orders such as labs, x-rays, medications, procedures, etc. With the use of electronic health records by most hospitals due to government mandates, the tracking board is a visual layout of the emergency department in electronic formatting as part of the electronic health record software. This tracking board is where a physician or other hospital staff may go to track a patient's progress through the emergency department. If an emergency physician decides to admit a patient, the physician typically asks a staff member to contact the admitting physician and any consulting physicians via a phone call or page through the hospital operator, answering service, or physician's office. The emergency physician then speaks with each of the admitting, primary care, and consulting physicians individually to discuss patient care. This contact can take place at all hours of the day and often requires multiple phone calls, causing a disruption in workflow, disruptions during busy clinic hours, and extensive after hours interactions.

It would be advantageous to provide a secure patient management system that allows for real-time tracking of patient care and provides secure interphysician communication to streamline physician interactions. It would also be advantageous to provide a secure patient management system that is compatible with computers, tablets, smartphones, and other mobile devices, allowing physicians to communicate directly with one another in real time or send delayed messages to prevent unnecessary interruptions. Lastly, it would also be advantageous to provide a secure patient management system that can integrate with current electronic medical records and electronic health record systems to document and save time-stamped communications, thus allowing other physicians participating in that patient's care to access the discussions and care plans, thus decreasing medicolegal liability.

### BRIEF SUMMARY OF THE INVENTION

A patient management system is provided herein, this system including a secure network-based system and method for interphysician communications. More specifically, the system of the present invention provides a way to track a patient's diagnosis and treatment following admission in the emergency department of a hospital, admission and discharge from a hospital, as well as providing a secure system of communication for emergency physicians, primary care physicians, and consulting specialist physicians regarding patient care and follow-up.

In a preferred embodiment, the patient management system of the present invention is a secure computing system or application that is compatible with desktop computers, laptops, tablets, smartphones, and the like. The system may be web-based or may function on secure cloud that is HIPPA compliant and capable of maintaining the level of security required for patient privacy. The system can interface with current electronic health record (EHR) software and is customizable to be compatible with a hospital's current EHR system. In this way, all communications are time-stamped and documented in a patient's records for HIPPA and medicolegal compliance and may be viewed by anyone with access to the EHR system. The application provides multiple user-profiles and preferably has computer-based formats for emergency physicians, non-emergency physicians, medical practice managers, and administrators, as well as mobile device formats for non-emergency physicians, primary physicians, hospitalists, and specialists. Due to the different physician roles, it is contemplated that emergency physicians may work primarily from a computer-based format, while non-emergency physicians may work primarily from a mobile-based format.

It is contemplated that this system can be installed on the computers and smartphones of client hospitals and physicians, thereby providing a way for emergency physicians, hospitalists, specialists, etc. to communicate in real-time regarding a patient's care. It is also contemplated that this system will allow for communications to be sent at delayed or scheduled intervals, thus allowing one physician to immediately draft a message and have the message saved in a que and automatically sent at a future time, so as not to disturb the message recipient after hours or during a time when the sending physician knows that the recipient physician may be busy.

The overall functionality of the present invention is the similar from physician to physician, although the role of each physician may be different. When a patient checks into the emergency department, his or her vital information will populate on a main hospital tracking board which tracks in real-time the presence and progress of each and every patient that comes through the emergency department. The appearance and organization of this main tracking board is typically determined by the electronic health records vendor utilized by a particular hospital. In a preferred embodiment of the present invention, this main tracking board is mimicked in real-time by the main home screen of the application, so that as a new patient is added to the emergency department, this same patient's information is added to the patient management system of the present invention. If an emergency room physician needs to communicate with another physician regarding a specific patient, that patient's name may be selected from the main home screen. The program then preferably takes the user to a specific patient home screen. From the patient home screen, communications regarding that specific patient may be made. An admitting physician, primary care physician, or consulting physician may be selected from a drop down list of physician names, and a customized message or template can be added to a text box. The sending physician can choose to either notify the recipient physician immediately or delay message delivery depending on the circumstance and urgency. The recipient physician then receives a notification that a new message is pending and may accept the message as is or respond to the message, thereby initiating a communication thread with another physician or physicians. Under certain circumstances, an emergency physician may need to send an image or photograph to a primary or consulting physician, for example an x-ray image may need to be sent to an orthopedic surgeon for review. In these cases, the emergency physician may log in to the application on his or her mobile device, take a photograph, and send the image to the recipient physician under the patient communication home screen.

### DESCRIPTION OF THE DRAWINGS

These and other features, aspects, and advantages of the present invention will become better understood with regard to the following description, appended claims, and accompanying drawings where:

FIG. 1 is a flow chart illustrating one embodiment of the patient management system of the present invention showing a preferred user-interface flow for an emergency department physician;

FIG. 2 is a flow chart illustrating one embodiment of the patient management system of the present invention showing a preferred user-interface flow for an immediate message received by a non-emergency physician;

FIG. 3 is a flow chart illustrating one embodiment of the patient management system of the present invention showing a preferred user-interface flow for a delayed message received by a non-emergency physician;

FIG. 4 illustrates one embodiment of the main home screen of the patient management system of the present invention;

FIG. 5 illustrates one embodiment of the patient home screen of the patient management system of the present invention;

FIG. 6 illustrates one embodiment of the patient communication screen of the patient management system of the present invention;

FIG. 7 illustrates a message thread included on one embodiment of the patient communication screen of the patient management system of the present invention;

FIG. 8 illustrates one embodiment of an immediate message notification sent by the patient management system of the present invention;

FIG. 9 illustrates one embodiment of a delayed message notification sent by the patient management system of the present invention;

FIG. 10 illustrates one embodiment of a home screen of the patient management system of the preset invention as it may be viewed on a mobile device; and

FIG. 11 illustrates one embodiment of communication initiated by a non-emergency physician from a mobile device.

### DETAILED DESCRIPTION OF THE INVENTION

The present invention is a patient management computing system comprised of an application or software to be implemented on a plurality of computing devices. The overall system comprises a computing system or server in communication with the computing devices, a processor coupled with a memory and configured to execute various functions such as tracking a patient's care and progress, secure messaging between physicians, as well as saving and exchanging data between the patient management system and an electronic health records system. The system may be web-based or cloud-based and may utilize wired or wireless networks.

In addition to implementation on a plurality of computing devices, a plurality of user profiles may be created—preferably one user profile per physician. It will be understood that there are numerous categories of computing devices with multiple user profiles that may benefit from implementations of the disclosed technology. For example, computing devices may include, but are not limited to, desktop computers, portable computers, tablets, netbooks, e-readers, personal data assistants, ultra mobile personal computers, and smartphones.

Various aspects described herein may be implemented using standard programming or engineering techniques to produce software, firmware, hardware, or any combination thereof to control a computing device to implement the disclosed subject matter. A computer-readable medium may include, for example: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the claimed subject matter.

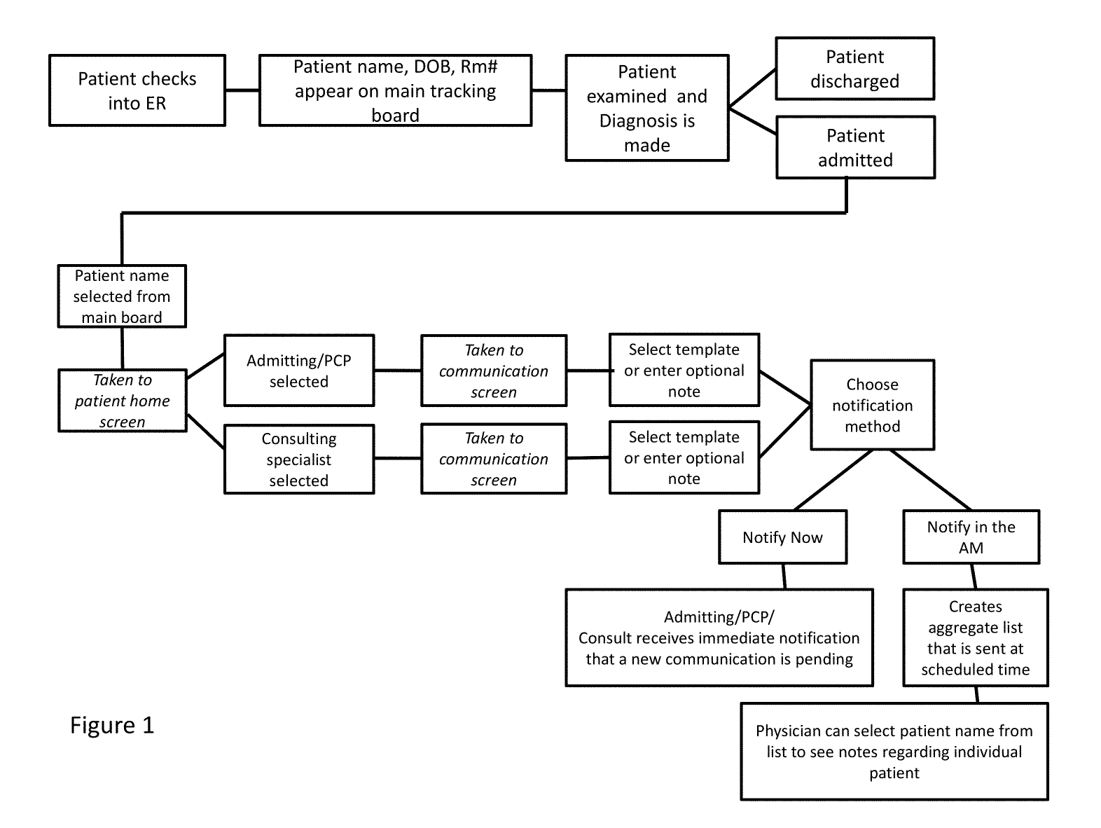

FIG. 1 illustrates the typical flow of a patient through the emergency department as well as the preferred flow through one embodiment of the patient management system as it specifically pertains to emergency physicians. As a patient checks into the ER, the patient's vital information populates on a main tracking board typically displayed on a computer monitor at a hospital work station. This information is part of the hospital's EHR system and typically includes the patient history and current information such as the patient's name, date of birth, room number, assigned nurse and assigned emergency physician. As a patient is examined, other information populates the tracking board such as orders for labs, xrays, medications, procedures, etc. As test results are returned and diagnoses are made, that information is associated with each patient as well. Ultimately, a decision is made to either discharge the patient and send him or her home, or admit the patient to the hospital. Either way, a physician other than the emergency room physician will typically need to be notified and assigned to assume that patient's care the moment that patient leaves the ER.

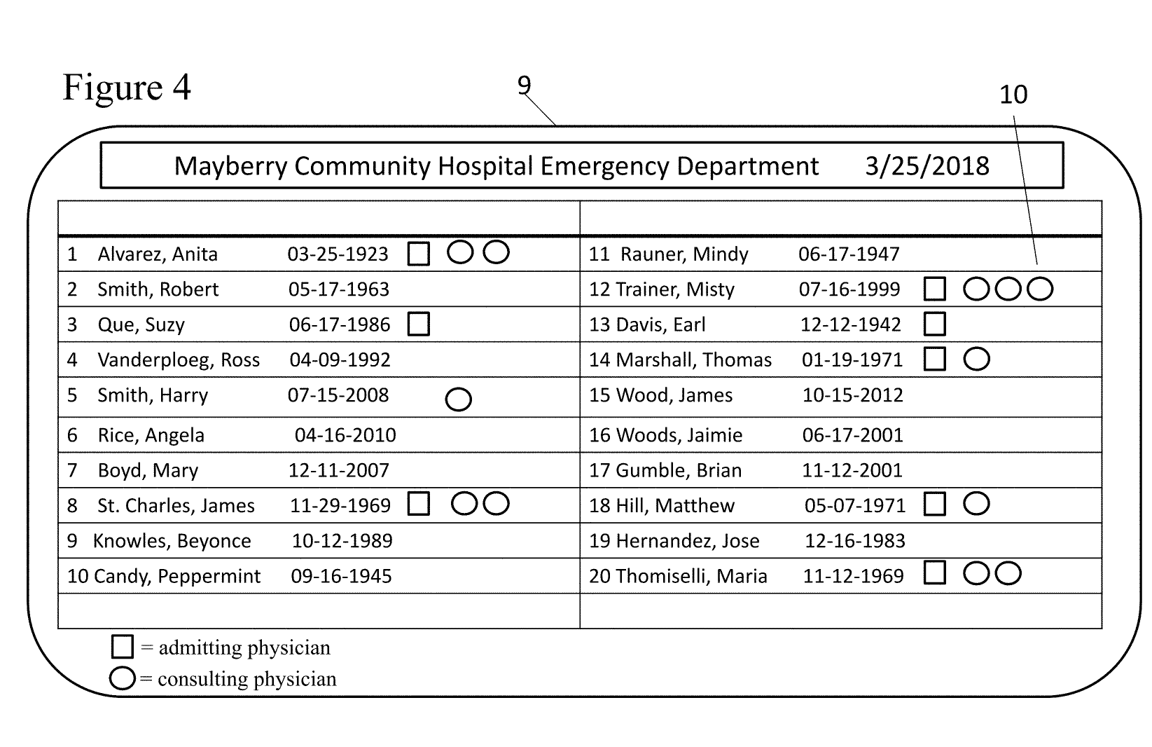

In a preferred embodiment, the patient management system of the present invention includes a main home screen 9, individual patient home screens, specific patient communication screens, notification screens, personalized patient lists, physician lists, and a record of patient-specific messages and photographs. The main home screen 9, which preferably mimics the main tracking board of the ER, allows the emergency physician to follow a patient's progress and care through this system as well. FIG. 4 illustrates one embodiment of the main home screen 9. This embodiment lists the patient's name, date of birth, and room number. Also the main home screen 9 preferably includes status indicators 10 that may flash or change colors depending on whether an interphysician communication is waiting/pending, in progress, or complete. Hospital work stations typically have dual monitors, and preferably this main home screen 9 is displayed on a second computer monitor adjacent the main hospital tracking board.

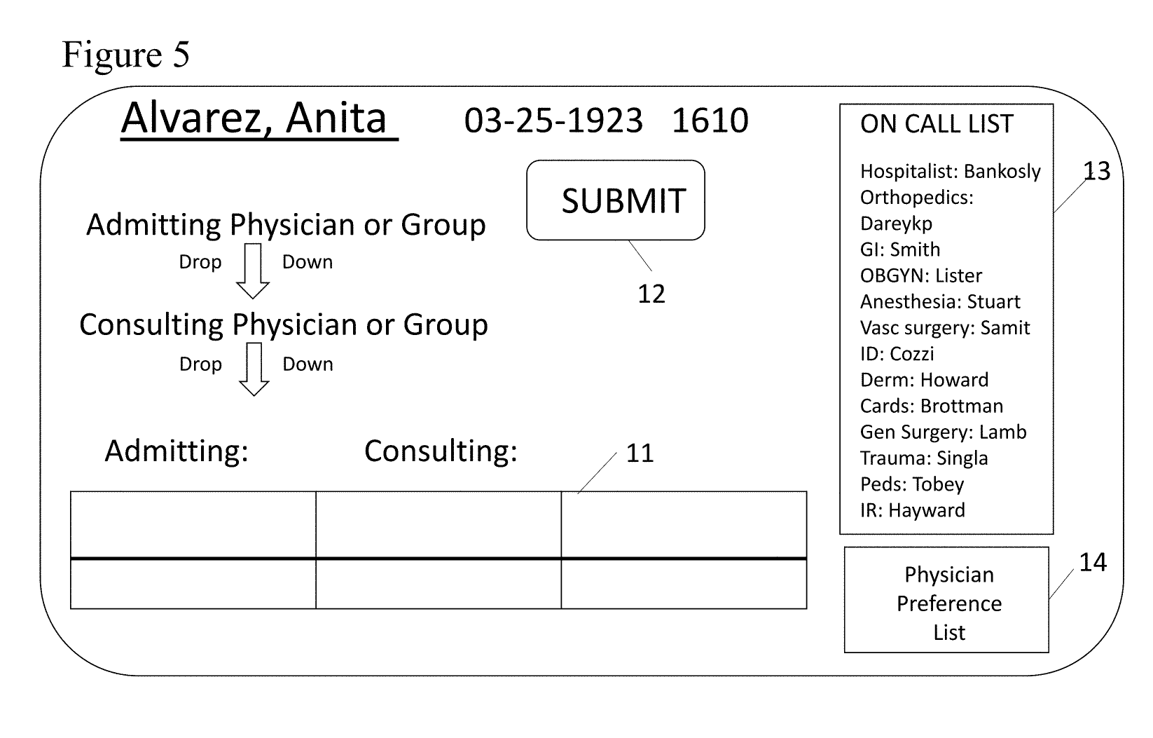

An example scenario using a preferred embodiment of the patient management system is described herein from the perspective of an emergency and a non-emergency physician. In an example scenario, an emergency physician examines a patient in the emergency department and determines that the patient should be admitted. This particular hospital admission requires the emergency physician to communicate with the patient's primary care physician as well as at least one consulting specialist. The emergency physician may then use the patient management system to initiate communication with the primary and specialist physician. In a preferred embodiment of the emergency physician user-interface, the emergency physician may select the patient's name from the main home screen 9, which then transitions to an individual patient home screen, illustrated by FIG. 5. This patient home screen may include a drop down box of physician names and a table that lists each selected physician 11. The emergency physician may select the desired primary care, admitting, or consulting physician (also referred to herein as “receiving physician”) from the admitting physician or consulting physician drop-down box. On this same patient home screen, there is preferably an on call list 13 that lists each physician that is on call during any given time, as well as a physician preference list 14 that may list the preferred specialists associated with a particular admitting physician. If the emergency physician is unsure of who to contact, he or she may consult either or both of these lists. A submit or return button 12, illustrated in FIG. 5, may be selected to send the application back to the main home screen.

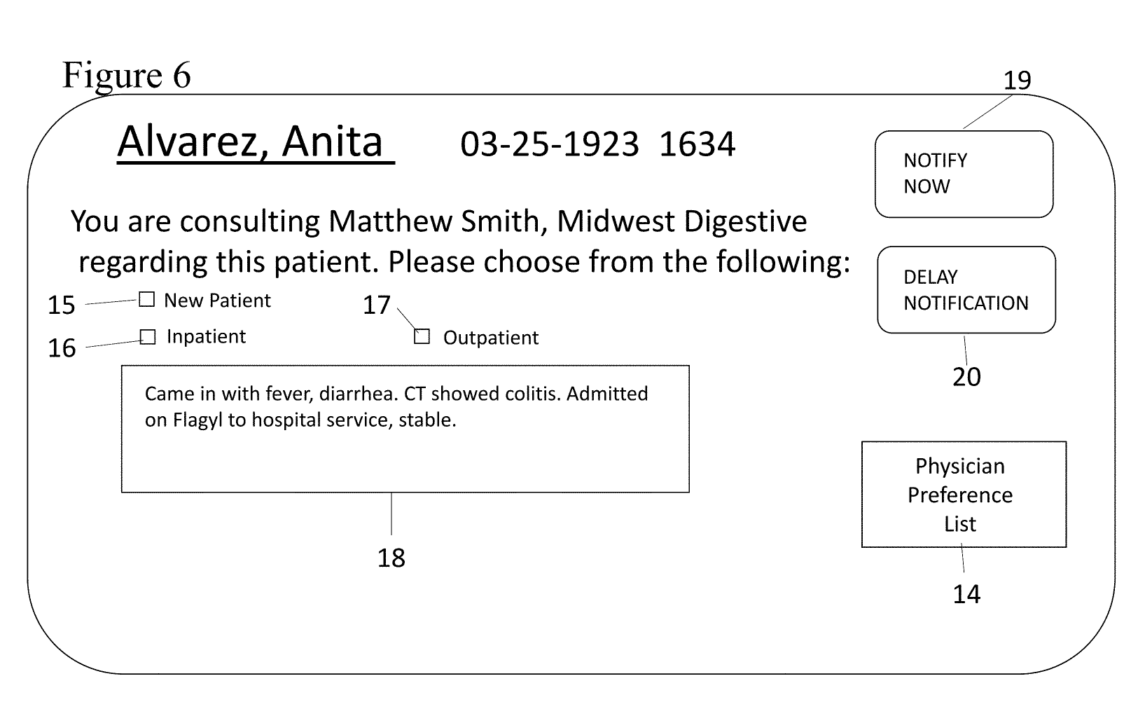

Once the admitting or consulting physician is chosen, that physician's name may populate the physician name table 11, and the screen may change to a communication screen illustrated by FIG. 6. In an embodiment shown in FIG. 6, this communication screen lists the patient's information, the admitting or consulting physician's information, and offers several options of communication for the emergency physician as well as a text box 18 for inputting communications. If the patient is new to the receiving physician, a new patient box 15 may be checked, indicating to the consulting/admitting physician that this particular patient has not been seen by this physician before. If the patient is a regular or return patient of the receiving physician or the physician's practice, then the new patient box 15 may be left unchecked. There may also be an inpatient box 16 and an outpatient box 17; the inpatient box 16 may be checked to indicate to the receiving physician that this patient is or needs to be admitted to the hospital, the outpatient box 17 may be checked to indicate that this patient has been discharged to go home. These options may also be available and used by primary care, hospitalist, or consultant physicians.

The emergency physician may then type a customized messaged to the receiving physician in the text box 18 or may select a template such as “Please call regarding patient.” The emergency physician may select an immediate notification button 19 or a delayed notification button 20. The immediate notification button 19 sends the message to the receiving physician immediately and may initiate a back and forth communication. The delayed notification button 20 preferably adds the message to a message list or que that is delivered to the receiving physician at a predetermined time, such as 7 am.

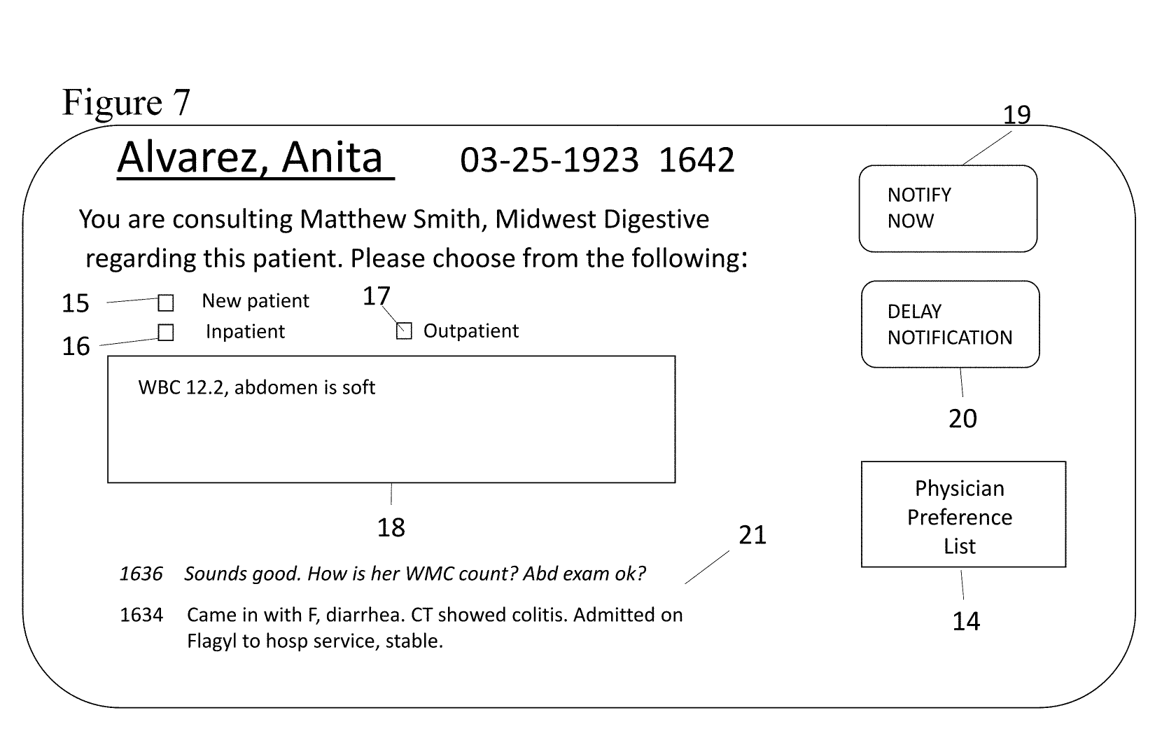

FIGS. 6 and 7 illustrate a live communication being sent via the immediate notification button 19. In this example, the patient is being admitted to the hospital, and a specialist needs to be consulted. The emergency physician has typed an initial message to the consulting physician, and has sent the message immediately. Once a live communication has been initiated, photographs or images may be sent in addition to text. For example, an x-ray image may be sent to an orthopedic surgeon, an EKG may be sent to a cardiologist, a photograph of a rash may be sent to a dermatologist, and so on. Referring back to the status indicators 10 that may be displayed on the main home screen 9, at this point in time, the status indicator 10 would preferably indicate that a message has been sent and is awaiting reply. For example, a red indicator may be present next to the patient's name.

FIG. 7 illustrates an active patient communication screen whereby the messages sent and received by both the emergency and consulting physician populate in a time-stamped message thread 21 viewable by both physicians. For clarification purposes, sent and received messages may be differentiated using color coding or another differentiation method. In this example, non-italicized text represents message(s) sent by the emergency physician, whereas the italicized text represents message(s) sent by the consulting physician. At this point in time, the status indicator 10 preferably indicates that a message has been acknowledged by the receiving physician and a response is in progress. For example, a flashing or blinking yellow indicator may be present next to the patient's name. In this way, if the emergency physician is viewing the main home screen and sees a flashing yellow indicator, he or she is aware that a response is in progress and may click on the yellow indicator to go directly to the patient message screen. Once communication is complete and ended, the status indicator 10 preferably displays that communication is complete. For example, a green indicator may be present next to the patient's name. Preferably, the message thread may be reviewed by the emergency physician at any time simply by clicking on a status indicator next to a patient's name. It is also contemplated that an emergency physician may re-initiate a conversation after the fact if the status of a patient changes or if the emergency physician forgot to impart specific information to the consulting physician. In this case, the status indicator may change from green back to yellow; or, the emergency physician can choose to send this additional message at a delayed time, in which case the status indicator may remain green.

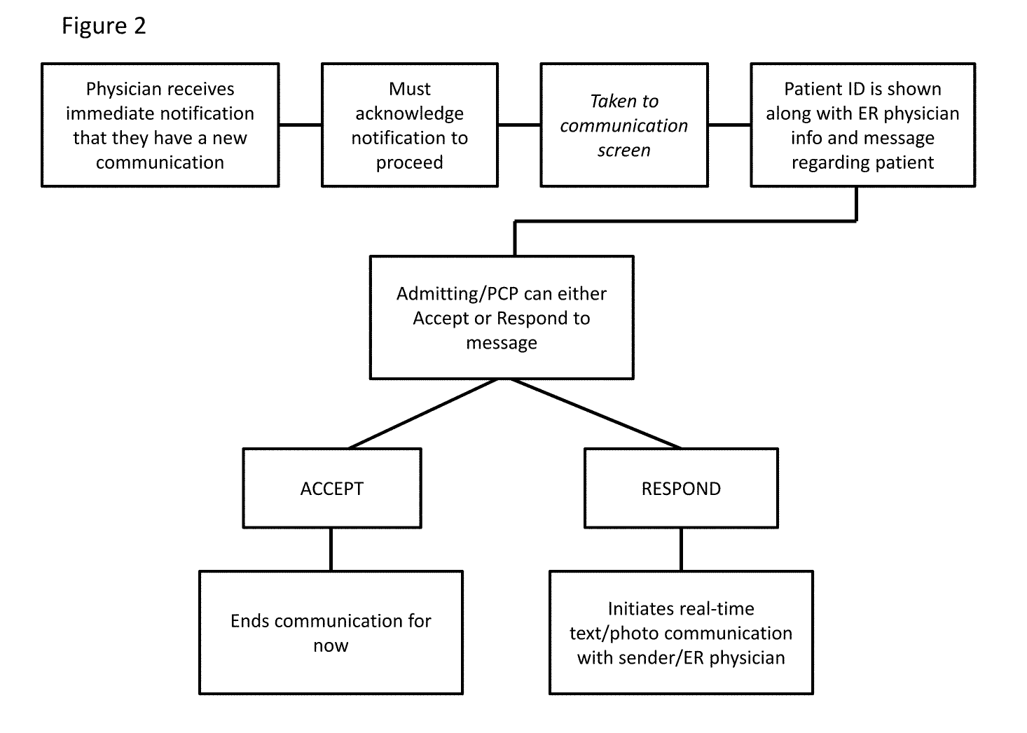

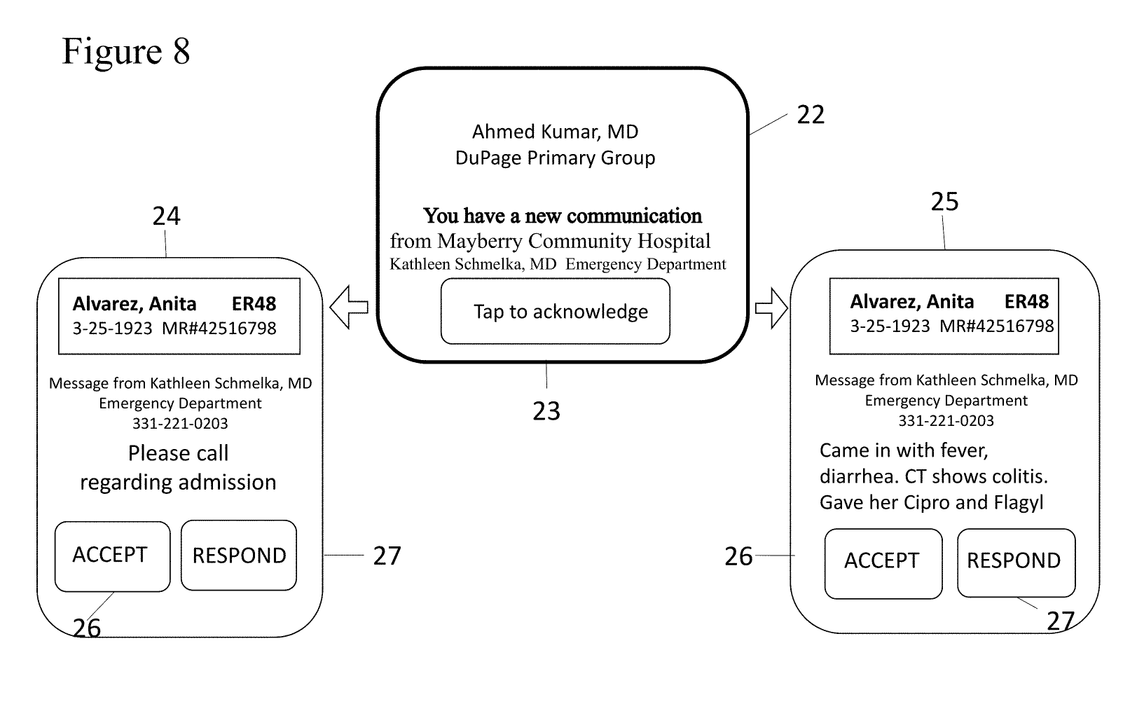

This same scenario is further described herein from a preferred user-interface of a non-emergency physician (i.e. primary care, specialist, etc.) FIG. 2 is a flow chart illustrating the main features or flow of the non-emergency physician user interface. First, the non-emergency physician may be alerted that a message is pending. At this point in time, the status indicator 10 on the main home screen 9 may indicate that a message has been sent and is awaiting a reply (i.e. red). FIG. 8 illustrates a notification screen 22 that may pop up on a receiving physician's mobile device along with an alert sound. Preferably, this notification is a push notification. A push message is data transmitted to the mobile device without prompting, or without the mobile device first having to check for messages. A message may be directed to a mobile device from, for example, an application server remote from the mobile device. In some instances, the message may be transmitted from the application server to a message server, which may manage message delivery for a plurality of mobile devices receiving push messages from a plurality of sources. In one embodiment, an acknowledgement button 23 must be pressed in order for the physician to proceed past this screen on his or her mobile device. In essence, the mobile device is disabled for other purposes until the pending message has been acknowledged, thus preventing a physician from dismissing the message without reviewing it first.

Once the message is acknowledged, the system may then advance to a communication screen. Screenshot 24 of FIG. 8 illustrates a “Please call regarding admission” template message received by a non-emergency physician, whereas screenshot 25 illustrates a customized message received including specific information regarding a patient. If the receiving physician does not want or need to send a reply message, an accept button 26 may be pressed, and the communication is complete. At this point in time, the status indicator 10 on the main home screen 9 may indicate that communication is complete (i.e. green). If the receiving physician wants or needs to reply to the message, a respond button 27 may be pressed, and real-time messaging back and forth may occur, similar to the screen illustrated by FIG. 7 whereby the message thread may be viewed. At this point in time, the status indicator 10 on the main home screen 9 may indicate that communication is pending (i.e. yellow). Once the physician is done exchanging information, he or she may press the accept 26 button to end the conversation and turn the status indicator 10 to complete (i.e. green).

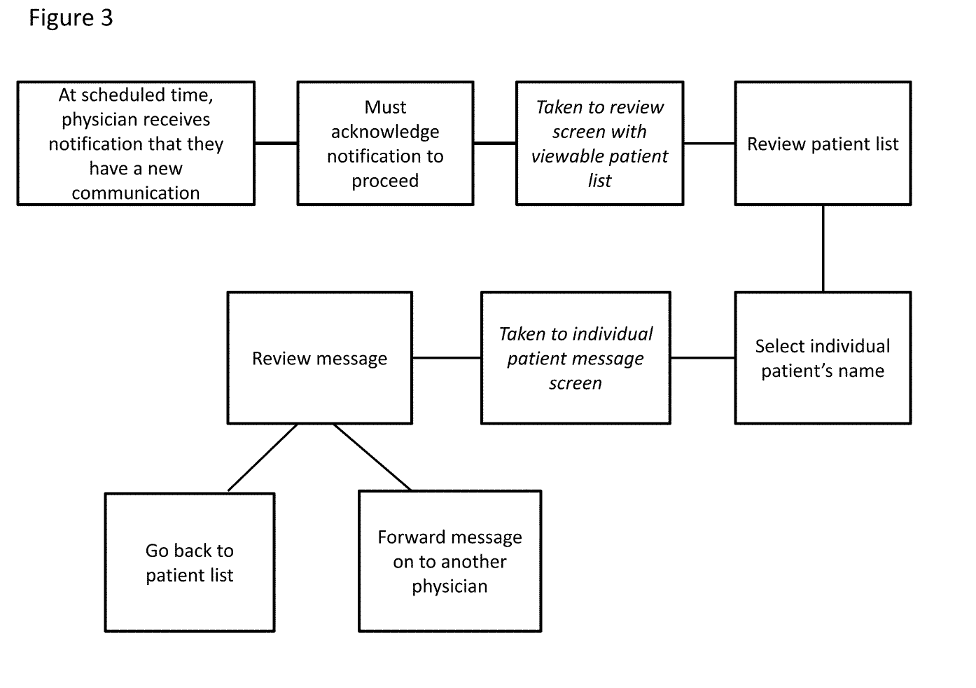

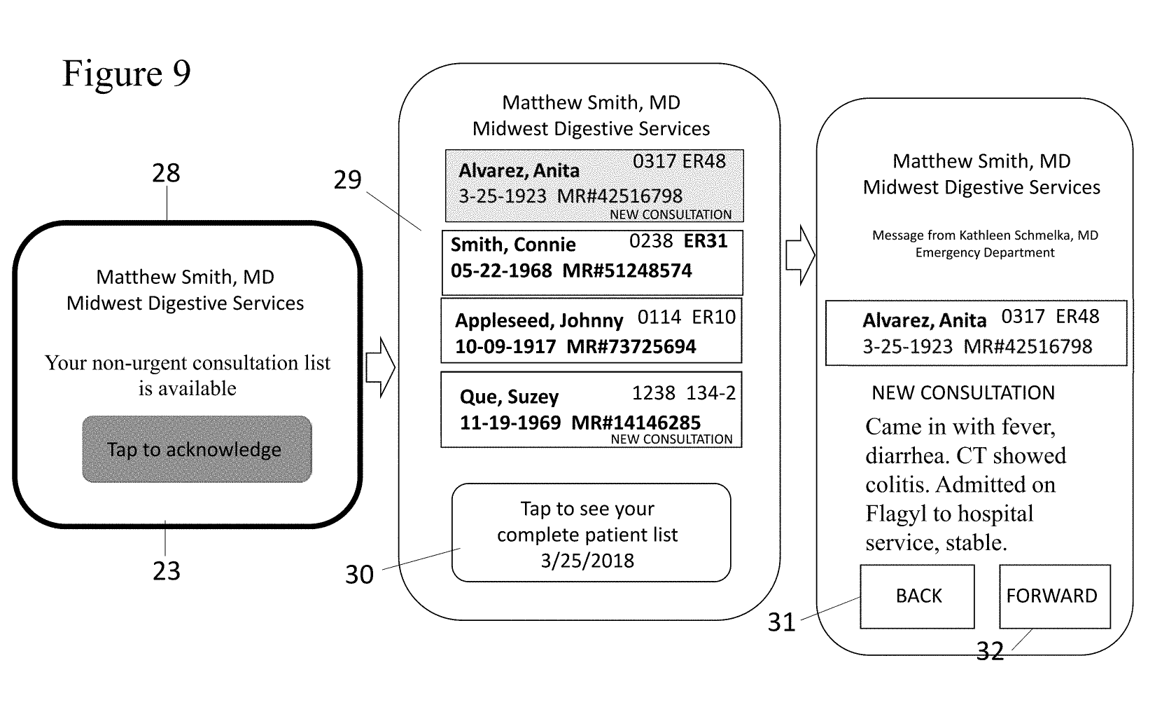

FIGS. 3 and 9 illustrate a preferred embodiment of delayed communication from a preferred user-interface of a non-emergency physician. It is up to the emergency physician's discretion and judgement as to whether a message should be sent immediately or if it can be sent at a later time. If an emergency physician chooses to delay the sending of a message, all of the delayed messages may be aggregated and sent at one predetermined and scheduled time point, for example 7 am, which is the typical time for physicians to go on or off call. In a preferred embodiment, all delayed notifications are automatically complete and cannot be replied to by the receiving physician. For strict liability and patient safety purposes, any communication that requires back and forth between two or more physicians must be completed as quickly as possible and should not be left open-ended, thereby putting messages at risk of being lost or forgotten. If an emergency physician needs to communicate directly with another physician, then immediate communication should occur. Delayed messaging is preferably reserved for instances where an emergency physician does not need to directly communicate with the non-emergency physician, for example a patient has been discharged and needs to follow up with the non-emergency physician at a later date, or needs a routine inpatient consultation that is straightforward, thus not requiring direct discussion.

For delayed communications, at the scheduled time a notification screen 28 may pop up on a receiving physician's mobile device. Similarly to active, immediate notifications, an acknowledgement button 23 preferably must be pressed in order for the physician to proceed past this screen on his or her mobile device. Once the notification screen is acknowledged, the physician may be routed directly to the application installed on the mobile device, and the physician may review his or her patient communication list 29. In a preferred embodiment, this list 29 may cover the past 24 to 48 hours; however, it is to be understood that any suitable time interval may be chosen. It is contemplated that this list 29 is not an active communication list, rather it provides the ability for a physician to review all the completed live and/or delayed communications that have occurred. The list 29 is preferably ordered in reverse chronological order and may be color-coded to differentiate whether the communication was initiated by an emergency physician or the non-emergency physician or whether the communication was a delayed message sent or a live but now completed communication that occurred in the past 24 to 48 hours. There may be two general categories of messages—messages initiated by the non-emergency physician and sent to another physician, and messages received by the non-emergency physician from another physician. It is preferable to have these two categories differentiated from one another using a method such as a different background color, outline color, using a different text, etc. Within these two categories, there may be messages sent in real-time and messages sent delayed. Similar to the status indicators on the main tracking screen, it is preferable to have an indicator as to whether these messages have been acknowledged and accepted or complete. The status indication theme may be similar, such as the red, yellow, green example used herein.

A button 30 may be included on the screen to display the full communication list so that a physician may scroll through a complete list of communications. If the physician wishes to review a specific communication record, the physician may select the patient's name from the list 29. The message thread 21 may then appear for physician review. A back to list button 31 may be included to exit out of a specific communication screen and back to the patient list 29. Additionally, a forward message 32 button may be included and selected if the physician wants or needs to forward that specific message on to another physician. For example, if a physician is off call at 7 am, but receives a delayed message at 7 am regarding a patient admission, that physician may forward the delayed message on to the next physician that is now on call. Since all of these communications are considered complete, at this point in time, the status indicator 10 on the main home screen 9 may indicate a complete communication (i.e. green).

Regarding message notifications, the system is preferably designed to alert a receiving physician every 5 minutes for 20 minutes, alerting louder at each 5 minute interval, until that receiving physician answers or acknowledges the alert. If there is no response after 15 minutes, the status indicator 10 on the main home screen 9 may begin to flash or blink, thus notifying the emergency physician that he or she may need to initiate a back-up method of communication. If the message goes unanswered after 20 minutes, then the system records that attempt as “complete” “no response”, and the emergency physician or sending physician should resort to actually calling the receiving physician on his or her home phone, mobile phone, office phone, etc. If a receiving physician is unresponsive, this unresponsiveness may be recorded in the system for the hospital administration and medical staff to see, and they can reprimand the physician accordingly. Meanwhile, the communication attempts of the emergency or sending are documented in both the patient management system and the electronic health records system.

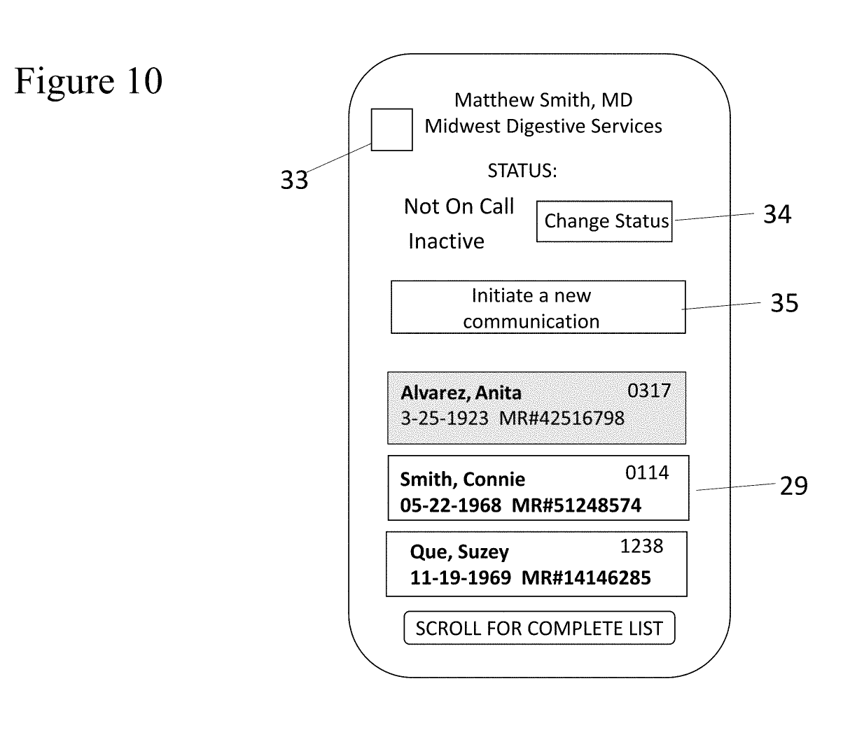

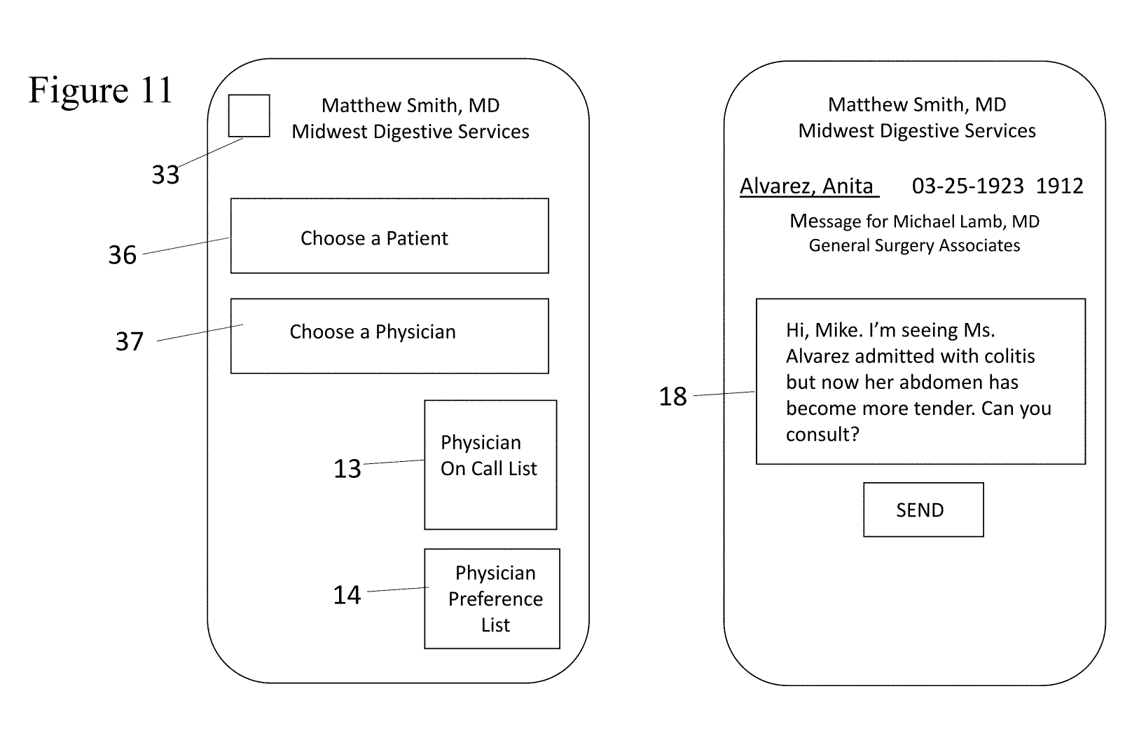

FIG. 10 illustrates an embodiment of the patient management system home screen as it might appear to a non-emergency physician upon opening the application from a mobile device. The home screen preferably includes a menu button 33 that can take the user to any area of the patient management system, as well as a change status button 34 whereby a physician may change his or her communication status depending on whether he or she is on call or not on call, actively receiving messages or not receiving messages. For example, a physician could be on call and actively taking all messages for a specialty group, whereby any message sent to any doctor in that group would be forwarded to this physician; a physician could be not on call but taking messages for his or her existing patients if the sending physician selects this physician's name specifically as the recipient; or a physician could be not on call and not taking any messages, whereby this physician can only receive messages forwarded to him or her specifically from persons within their specialty group. The home screen also may include a patient communication list 29 similar to FIG. 9 as well as a button to initiate new communications 35. This feature allows any non-emergency physician to initiate communication with any other physician if necessary. For example, if one consulting physician decides that another consulting physician needs to be brought in on a case, the first consulting physician may select button 35, then select the patient name 36 from the screen illustrated by FIG. 11, and select the second consulting physician 37 from the physician list. Next, the physicians may communicate back and forth by entering a message in the text box and hitting send. The patient's name may be color coded to indicate communication status, similarly to the status indicators 10 on the emergency physician's main home screen.

As mentioned previously, this patient management system preferably operates on a secure cloud. The security level of this cloud preferably meets the standards for HIPPA compliance. The system also preferably operates on the same security hub as the client hospital's current electronic health records system so that information can be easily exchanged from one system to the other, yet remain separate to prevent transmission of any viruses or other possible electronic contaminants. The patient information stored in the electronic health records may be exchanged and uploaded to the patient management system, thus populating the main home screen with the same or similar information that populates the main tracking board of the emergency department. Additionally, all communications sent in the patient management system may be time stamped and documented and then exchanged or uploaded to the EHR system. Preferably these communications may be stored in one area for review, such as under a tab labeled Communications, thus easily accessible for other practitioners involved in that patient's care. In this way, any physicians, staff, managers, administrators, attorneys etc. with access to the EHR may pull up any current or past communications regarding any patient that has ever been in the EHR system. Moreover, any liability of the doctors or hospital due to lack of communication or miscommunication is reduced, as all communications are recorded and available for review. This information exchange preferably happens at a predetermined interval. Although the frequency of information exchange between the secure cloud and the system of the present invention may be any suitable time interval, in a preferred embodiment, complete communications may be uploaded to a secure cloud at 15 minute intervals. The selected time interval is preferably such that patient information is readily available without it being cost prohibitive to run the system.

In a preferred embodiment, communications taking place within the patient management system are not uploaded to the cloud until the communication is marked “complete”. Live communications between an emergency physician and a non-emergency physician may occur if the emergency physician initiates an immediate communication with the non-emergency physician. Regardless of how long the communication exchange takes, the exchange may not be marked “complete” until both physicians are done communicating. Delayed communications are automatically “complete”, as the emergency physician is typically not still available at the time these are accessed and thus is no longer available for the receiving physician to communicate with actively; so, if the receiving physician needs to follow-up on a delayed communication, he or she would then need to initiate a new communication with the primary care physician or the physician on the floor of the hospital where the patient was admitted. Once a communication is “complete”, it is uploaded to the secure cloud at the next predetermined (i.e. 15 minute) interval, whereby the communication is recorded and documented in the patient's electronic health records for all with access to see.

The appearance and layout of the patient management system is customizable to match each client hospital's current electronic health record vendor's version of an ER tracking board, so as to provide uniformity between the patient management system and the hospital's current EHR. For example, the main home screen 9 of the patient management system can be designed to match the layout and style of the main tracking board of the EHR. Also, the patient management system may be customized to incorporate the colors and logo of the client hospital.

Although the patient management system of the present invention has been described in detail with reference to particular embodiments and time intervals, the embodiments are for illustrative purposes only and do not limit the invention. It is to be appreciated that those skilled in the art can change or modify the embodiments without departing from the scope and spirit of the invention. It is to be understood that the inventive concept is not to be considered limited to the constructions and intervals disclosed herein.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having.” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

What is claimed is:

1. A patient management system for tracking patient care and providing secure interphysician communications comprising:
a computing system adapted for installation on a network computing devices, whereby said computing system is further adapted to interface with a hospital electronic medical record system thereby facilitating a two-way exchange of information between said computing system and the electronic medical record system;
said computing system including at least one function to track patient progress through a hospital system, said function including at least a main home screen for displaying vital patient information;
said computing system including a secure messaging function for communication whereby a physician may send at least one communication to at least one other physician regarding a specific patient's care, said secure messaging function including an instant messaging option and a delayed messaging option, such that a sender may choose to send a message immediately for live communication or delayed to prevent disrupting a recipient; and
said computing system including an alert function to alert a message recipient that a message is available for review.

2. The patient management system of claim 1, wherein said computing system is cloud-based and customizable for a client.

3. The patient management system of claim 1, wherein the system includes a first user-interface for emergency physicians and a second user-interface for non-emergency physicians, whereby the emergency physician user-interface operates primarily from a desktop-based device and the non-emergency physician user-interface operates primarily from a mobile device.

4. The patient management system of claim 1, wherein the main home screen further includes at least three different status indicators for indicating when a message regarding a patient is pending, in progress, and complete.

5. The patient management system of claim 1, wherein the secure messaging function includes a patient communication screen from which communication may be initiated and reviewed.

6. The patient management system of claim 5, wherein said patient communication screen includes a text box for inputting messages, a function for selecting at least one physician to add as a message recipient, and a function for inserting images.

7. The patient management system of claim 5, wherein said patient communication screen further includes a function for differentiating whether a patient is a new patient, an inpatient, and an outpatient, a function for accessing a list of physicians on call, and a function for accessing a list of preferred physicians.

8. The patient management system of claim 1, wherein said alert function is an alert sound in conjunction with a notification displayed on a physician's mobile device.

9. The patient management system of claim 8, wherein said alert function disables other mobile device functions until said notification is acknowledged by the user, and whereby acknowledgement of said notification results in the display of the messages available for review.

10. The patient management system of claim 1, further including a review screen whereby a non-emergency physician may review a list of past patient communications, and wherein said review screen includes a function for forwarding said past communications on to another physician.

11. A patient management system for tracking patient care and providing secure interphysician communications comprising:
at least one computing system in communication with a plurality of computing devices and each of said plurality of computing devices having at least one user profile, and whereby said at least one computing system is further adapted to interface with a hospital electronic medical record system thereby facilitating a two-way exchange of information between said application and the electronic medical record system;
at least one processor operatively coupled to said at least one computing system;
at least one memory operatively coupled to said at least one processor and configured for storing data and instructions that execute at least one function for tracking patient progress through a hospital system, said function including at least a main home screen for displaying vital patient information;
said at least one processor executing a secure messaging function for communication whereby a physician may send at least one communication to at least one other physician regarding a specific patient's care, said secure messaging function including an instant messaging option and a delayed messaging option, such that a sender may choose to send a message immediately for live communication or delayed to prevent disrupting a recipient; and
said at least one processor executing an alert function to alert a message recipient that a message is available for review.

12. The patient management system of claim 11, wherein said computing system is cloud-based.

13. The patient management system of claim 11, wherein the system includes a first user-interface for emergency physicians and a second user-interface for non-emergency physicians, whereby the emergency physician user-interface operates primarily from a desktop-based device and the non-emergency physician user-interface operates primarily from a mobile device.

14. The patient management system of claim 1, wherein said alert function is an alert sound in conjunction with a notification displayed on a physician's mobile device.

15. The patient management system of claim 14, wherein said alert function disables other mobile device functions until said notification is acknowledged by the user, and whereby acknowledgement of said notification results in the display of the messages available for review.

16. A patient management system for tracking patient care and providing secure interphysician communications comprising:
at least one computing system in communication with a plurality of computing devices and each of said plurality of computing devices having at least one user profile, and whereby said at least one computing system is further adapted to interface with a hospital electronic medical record system thereby facilitating a two-way exchange of information between said application and the electronic medical record system;
at least one processor operatively coupled to said at least one computing system;
at least one memory operatively coupled to said at least one processor and configured for storing data and instructions that execute at least one function for tracking patient progress through a hospital system, said function for tracking patient progress including at least a main home screen for displaying vital patient information;
said at least one processor executing a secure messaging function for communication whereby a physician may send at least one communication to at least one other physician regarding a specific patient's care, said secure messaging function including an instant messaging option and a delayed messaging option, such that a sender may choose to send a message immediately for live communication or delayed to prevent disrupting a recipient;
wherein the secure messaging function includes a patient communication screen from which communication may be initiated and reviewed, and wherein said patient communication screen includes a text box for inputting messages, a function for selecting at least one physician to add as a message recipient, and a function for inserting images;
wherein the main home screen further includes at least three different status indicators for indicating when a communication regarding a patient is pending, in progress, and complete;
said at least one processor executing an alert function to alert a message recipient that a communication is available for review; and
said at least one user-profile displaying a review screen whereby a user can review a list of past patient communications, and wherein said review screen includes a function for forwarding said past communications on to another physician.

17. The patient management system of claim 16, wherein said patient communication screen further includes a function for differentiating whether a patient is a new patient, an inpatient, and an outpatient, a function for accessing a list of physicians on call, and a function for accessing a list of preferred physicians.

18. The patient management system of claim 16, wherein said alert function is an alert sound in conjunction with a notification displayed on a physician's mobile device.

19. The patient management system of claim 16, wherein said alert function disables other mobile device functions until said notification is acknowledged by the user, and whereby acknowledgement of said notification results in the display of the messages available for review.

20. A method of managing patient care and interphysician communication within an emergency department of a hospital comprising the steps of:
providing a computing system in communication with a plurality of computing devices, whereby said computing system executes functions for tracking patient care and for communicating securely from one user to another;
interfacing said computing system in communication with a preexisting electronic health record system to provide a two-way information exchange between the computing system and the electronic health record system; and
exchanging information between said memory and said electronic health record system at a predetermined interval.

21. The method of claim 20, further including the steps of:
interfacing said computing system with a secure cloud server; and
uploading information exchanged between said computing system and said electronic health record system to the secure cloud server.

22. A method of managing patient care and interphysician communication within an emergency department of a hospital comprising the steps of:
providing computing system for managing patient care and for communicating securely from one user to another user;
installing said computing system on a secure network of computers and mobile devices;
performing a patient examination;
determining that a communication regarding a patient should be initiated;
selecting said patient's name from said computing system along with the name of each physician to be contacted regarding the patient;
entering a message to the selected recipient physician;
determining whether the message should be sent immediately or whether the message should be delayed and sent at a later scheduled time;
sending said message to said selected recipient physician; and
alerting said recipient physician that a message has been sent.

23. The method of claim 22, further including the steps of:
interfacing said application with a preexisting electronic health record system to provide a two-way information exchange between the application and the electronic health record system; and
exchanging information between said application and said electronic health record system at a predetermined interval.
